(19) United States
(12) Patent Application Publication
(10) Pub. No.: US 2005/0041609 A1
(43) Pub. Date: Feb. 24, 2005

(54) Propagation network

(76) Inventor: David H. Scheidt, Edgewater, MD (US)

Correspondence Address: The Johns Hopkins University;Applied Physics Laboratory, 11100 Johns Hopkins Road, Mail Stop 7-156, Laurel, MD, 20723-6099, US

(21) Appl. No.: 10/915,086

(22) Filed: Aug. 10, 2004

Related U.S. Application Data
(60) Provisional application No. 60/497,427, filed on Aug. 22, 2003.

(51) Int. Cl. H04Q 11/00

(52) U.S. Cl. 370/312

(57) ABSTRACT

The present invention is directed to a network communications system the purpose of which is to foster cooperation between synergistic nodes. Such a network is designed specifically to support information gathering and dissemination and is not intended as a general-purpose communications network. In particular, network communications involve transmitting nodes “blindly” broadcasting information in all directions without consideration for the identity of receiving nodes; and receiving nodes “blindly” receiving information, accepting all transmissions on a pre-defined frequency regardless of, and without knowledge of, origin.

### CROSS REFERENCE TO RELATED APPLICATIONS

This application claims priority to U.S. Provisional Application No. 60/497,427, filed Aug. 22, 2003, the entire contents and substance of which are hereby incorporated in total by reference.

### FIELD OF THE INVENTION

This application relates to the field of wireless data communication networks, and more particularly to establishing a communication network to support incoherent broadcasts between unnamed nodes. In such communications transmitting nodes “blindly” broadcast information in all directions without consideration for the identity of receiving nodes; and receiving nodes “blindly” receive information, accepting all transmissions on a pre-defined frequency regardless of, and without knowledge of, origin.

### BACKGROUND OF THE INVENTION

Three general types of communication network systems are commonly used today: Broadcast networks, Telecommunications Networks and Server-Based Computer Networks. Broadcast networks communicate information from sources to receivers as incoherent wireless broadcasts. This communication technique may be used to convey information to millions of receivers with a single broadcast. An additional advantage of wireless broadcast networks is that they require no infrastructure outside of the transmitter and receivers. Telecommunication networks use directed communications to support bi-directional information flow allowing individual nodes to both transmit and receive information. Another advantage of telecommunications networks is that they allow for communication between nodes that cannot directly communicate. A specialized case of telecommunications networks is the computer network; a distinguishing feature of which is the ability to support the asynchronous transfer of information through the use of servers. There exist situations in which such general purpose communication systems are not well suited. One example is a situation in which the primary goal of the system is to gather and disseminate information that is being acquired by nodes of the system. In such a situation the network need not support explicit communications between arbitrary nodes; rather, information should be disseminated appropriately across the network. The present invention relates to such a communication network having a primary function of gathering and disseminating information. In this network a transmitting node blindly broadcasts information in all directions without concern of who the recipients are. The communication system of the present invention is particularly applicable in situations where information is being transferred between cooperating intelligent and semi-intelligent entities. Moreover, the present invention permits such signaling to be performed in a highly dynamic environment. Examples of such situations are: cars that wish to provide their drivers with traffic conditions of the road ahead and ad hoc collections of unmanned vehicles on a search and destroy mission. Further applications relate to communications involving cooperative entities that use heterarchical control including, but not limited to entities that use: swarm behavior, potential fields and Markov blankets.

### SUMMARY OF THE INVENTION

The present invention is directed to a network communications system the purpose of which is to foster cooperation between synergistic nodes. Such a network is designed specifically to support information gathering and dissemination and is not intended as a general-purpose communications network. That is, the communication system of the present invention network is not intended to specifically support explicit communications between arbitrary nodes; rather, it enables information to be disseminated appropriately across the network. Additionally, because the intended use of the network is to foster cooperation in a highly dynamic environment (e.g. cars moving on a roadway system), the present invention creates a network that is highly robust and supports ad hoc formation.

To achieve these various goals, the communications network of the present invention exhibits various features derived from one or more of the prior art communications networks noted above. In particular, it exhibits the following desired features:
Transmit efficiently,
Transfer information between nodes that are not in direct communication,
Use no infrastructure other than nodes;
Support bi-directional transmission of information, and
Support asynchronous transfer of information.

The networking mechanism used in the present invention to satisfy these conditions shall be referred to herein as a propagation network. In such a propagation network, incoherent broadcasts occur between unnamed nodes. That is, transmitting nodes blindly broadcast information in all directions without consideration for the identity of receivers; and receiving nodes blindly receive information, accepting all transmissions on a pre-defined frequency regardless of, and without knowledge of, origin.

### BRIEF DESCRIPTION OF THE DRAWINGS

Various embodiments of the present invention will now be described in detail in conjunction with the annexed drawings, in which:

FIG. 1 illustrates an embodiment of the invention having a three-layer communication structure;

FIG. 2 illustrates an exemplary format for data transmitted by a network node and,

FIG. 3 illustrates an embodiment of the invention in which the network comprises three nodes.

### DETAILED DESCRIPTION

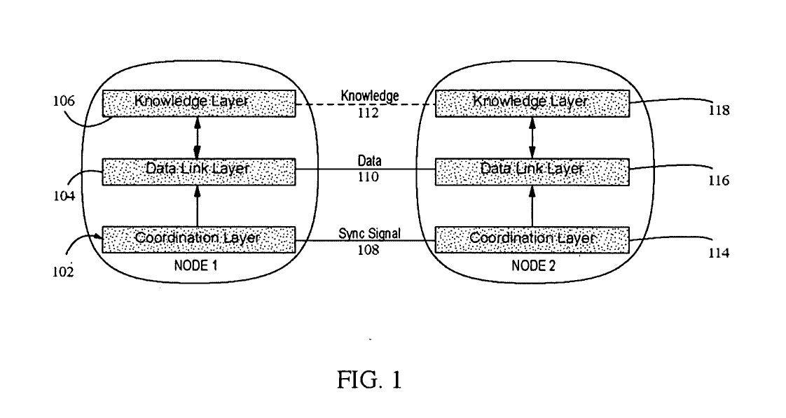

In one embodiment of the invention the network comprises a collection of nodes, each having the capability of wireless transmitting and receiving of information. Further, at least some of these nodes are capable of gathering information through sensors. FIG. 1 illustrates an embodiment of the invention in which the depicted propagation network comprises a three-layer architecture. Two nodes are illustrated, each having this three layer structure. As illustrated with respect to Node 1, the architecture's lowest layer is the coordination layer 102. The coordination layer is responsible for assuring that proximate nodes in the network transmit at differing times. As defined herein, the term proximate node is intended to mean a node that is sufficiently close to a subject node that either the subject node can “hear” a transmission of the proximate node and/or the proximate node can “hear” a transmission of the subject node (i.e. proximate nodes are nodes whose communications are capable of interfering with one another).

The middle layer is the data link layer 104. Similar to the data link layer in an Open System Interconnection (OSI) model, this layer is responsible for packing and unpacking packetized information transmitted between cooperating entities. Thus, as illustrated in FIG. 1, data 110 is communicated at this level between node 1 and node 2.

The upper layer is the knowledge layer 106. The knowledge layer is responsible for maintaining the node's knowledge base, a repository of “known” facts. The knowledge layer uses facts received from other nodes as well as facts organically derived from within the nodes (e.g. observations from sensors) to populate the knowledge base. In addition, the knowledge layer is responsible for determining when and what information should be transmitted. Each of these three layers will now be discussed in greater detail.

Coordination Layer

In an embodiment of the invention, the principle function of the coordination layer is to time-multiplex communicating nodes so that they make use of time available for communications while preventing simultaneous transmission. In this embodiment, secondary functions of the coordination layer are to determine the duration of allowable transmission bursts and to determine the density of proximate nodes. The density of proximate nodes is used by the knowledge layer to determine when, and what, knowledge should be transmitted.

To accomplish these functions, the coordination layer 102 periodically sends a transmit now (t) signal to the data link layer 104 indicating the data link layer may transmit after a fixed delay (εₜ). Along with this t signal, the coordination layer also supplies the data link layer with the two transmission parameters: the maximum permitted length of transmission (Lₜ) and the current node count (Nₜ). These parameters are determined for each individual node by essentially listening and counting the number of synchronization pulses signals emanating from neighboring, proximate nodes. That is, each node periodically transmits a short synchronization pulse signal 108. In a further embodiment of the invention, such pulse signals are sent by all nodes at a frequency (ωᵢ). Overlapping transmissions are avoided by engendering phase distribution across communicating nodes by utilizing the well-known principle of coupled oscillation. By way of example, one embodiment of the invention has each node adjust its phase θᵢ in accordance with the equation:
θᵢ′=θᵢ+K₁/Nₜ(Σ(cos(K₂θⱼ));
where θᵢ denotes the “next” θᵢ; K₁ and K₂ are constants, Nₜ is the number of nodes “heard” and θⱼ is the phase (as indicated by a received pulse) of a neighboring node.

In an additional embodiment the length of transmission Lₜ is derived from the equation:
Lₜ=ωᵢ/K₃Nₜ where K₃ is a constant.

It should be noted that Nₜ will not only vary as a function of time but will vary between nodes. That is, as the present invention contemplates mobile nodes whose positions change relative to one another, the number of neighboring nodes whose transmissions are capable of being heard will vary. Values for K₁, K₂ and K₃ are determined to synchronize communications in a way that is frequency locked and anti-phase. In various embodiments of the invention, these K's are set to initial values based on characteristics of the network (e.g., number of nodes, range of node communications, size of information to be communicated at a given time, etc.).

Data Link Layer

In an embodiment of the invention the data link layer 104 transmits data between nodes. The data being communicated relates to beliefs. A belief is data that has some degree of truth and is assumed to be true. In this embodiment of the invention the nodes have synergistic goals and operate on the same belief system.

By way of example, in a network where nodes monitor traffic conditions, each node might be a car having its speedometer and Global Positioning System as its sensors. In this example a slow speed on a section of interstate highway would be used to form the belief that “traffic is heavy at mile marker 109.”

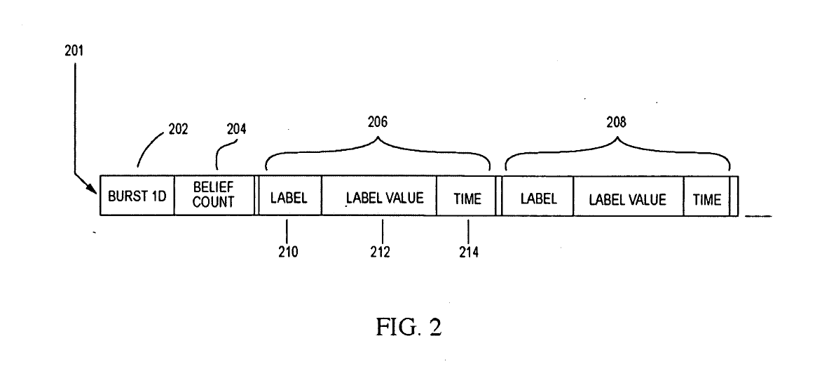

The data link layer 104 transmits this data in bursts. Bursts are a continuous stream of bytes whose time of transmission is less than Lₜ. As depicted in FIG. 2, a burst 201 consists of a sequence of one or more beliefs (206, 208, . . . ) preceded by a burst id 202 and a belief count 204. In one embodiment of the invention the burst id is simply a sequential, 8-bit counter (that resets to 0 after 256 transmissions). Each belief consists of a label 210, which identifies the type of belief; a value 212 for the label; and a time field 214 associated with the belief, where this time is relative to the time of transmission. In further embodiments of the invention, this time field is optional.

In additional embodiments of the invention transmission, reliability may be enhanced by borrowing receipt acknowledgement strategies for point-to-point communications commonly used in computer networks to the data link layer. Transmission security may be enhanced in the data link layer by encoding packets with encryption based upon a one-time pad; a one time pad that is provided to each cooperating entity at deployment. Public-key private key encryption strategies are not applicable to this type of network as nodes are unnamed.

Knowledge Layer

In this embodiment of the invention the knowledge layer 106 is focused upon the administration of an internal representation of known facts known as the knowledge base. The nature of knowledge and the mechanisms for fusing and reducing knowledge are well-known and vary with a network's particular application. As the propagation networks of the present invention are intended for a wide variety of applications, the nature of knowledge will not be addressed here. Rather this description of the present invention will focus upon the construction and requirements necessary for the knowledge layer to fulfill its role.

The knowledge layer performs two functions. First, the knowledge layer accepts beliefs and merges them into the knowledge base. Beliefs may be accepted from the node's sensors or from transmissions received through the data link layer. In merging the beliefs the knowledge layer must resolve contradictory beliefs and (as necessary) reduce the complexity of the knowledge base by various well-known techniques such as compression, removal of less important knowledge, and aggregation.

The second role of the knowledge layer is the generation of beliefs to be transmitted. Beliefs are transmitted in two forms: partial transmissions, in which only select beliefs determined by the knowledge layer to be of particular importance are transmitted; and complete beliefs in which all beliefs within the knowledge base are transmitted. When newly received information changes the belief state, the list of beliefs that have changed is sent to the data link layer. Also, when a new cooperating entity arrives (as indicated by a rise in the node count Nₜ) a list of all currently held beliefs is sent to the data link layer. Upon receiving a list of beliefs the data link layer decomposes the list into one or more bursts. Beliefs are transmitted according to the following simple algorithm:
If Nₜ<1 then Transmit nothing
Else if Nₜ>Nₜ₋₁ then Transmit complete belief
Else Transmit ∀beliefᵢ for which (beliefᵢ at time t)≠(belief at time t-1).

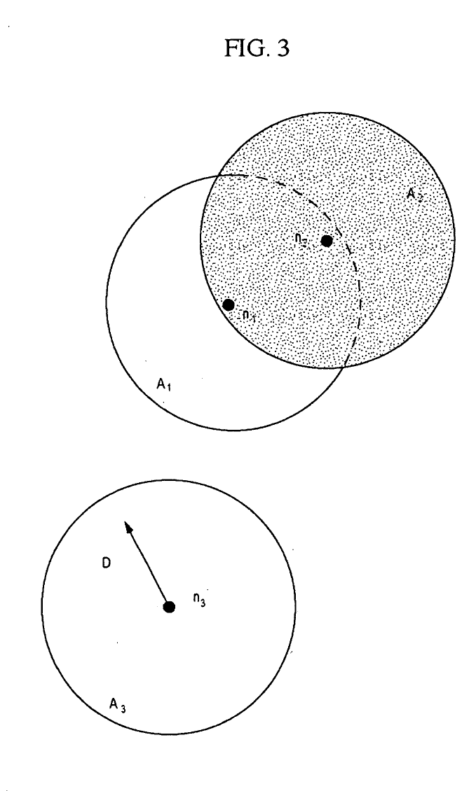

FIG. 3 illustrates an example of the present invention in which three nodes n₁, n₂ and n₃ of a propagation network are depicted. Each of these nodes is depicted as a center of a circle, the area of which (A₁, A₂ and A₃, respectively) represents its area of communication. In this example, the broadcast range of each node's transmitter is assumed to be equal to the range of its ability to receive signals, these ranges are equal for all three depicted nodes, and these ranges are depicted as being symmetric circles with the node at the center. These assumptions are not meant to imply any limitations on the present invention but are merely invoked to simplify the drawing.

In this example and as described previously above, each of the nodes periodically transmits a synchronization pulse 108. As illustrated by the depicted communication ranges, node n₁, being in n₂'s area of communication, hears the synchronization pulse of node n₂ but not that of n₃. Consequently at time t depicted in FIG. 3, Nₜ of node n; is 1. FIG. 3 also depicts an arrow, D, indicating the direction of motion of n₃ relative to n₁. Accordingly, at some future time Nₜ, n₃ will be “heard” by n₁ and N_{t′}=2. Upon this increase in Nₜ, the above described algorithm will trigger n₁ to broadcast its complete belief list to all of its proximate nodes (to include n₃). Similarly n₃ will at some point recognize that it has an additional proximate node and will transmit its complete belief list. In this manner information is shared between new members on the scene.

The communication algorithms above also describe how a changed belief would be transmitted. Thus by way of example, information gathered by n₂'s sensor may trigger it to communicate a changed belief. Receiving this information may cause n₁ to similarly broadcast a changed belief—perhaps to one of its proximate nodes which may not be in the communication range of n₂. In this manner communication propagates throughout the network without any infrastructure other than the nodes.

While the invention has been described with reference to the preferred embodiment thereof, it will be appreciated by those of ordinary skill in the art that modifications can be made to the structure and elements of the invention without departing from the spirit and scope of the invention as a whole.

1. A wireless data communication network comprising at least two nodes, each of said nodes having a transmitter and a receiver, wherein communication within said network comprises:
a transmitting node and at least one receiving node wherein the transmitting node broadcasts data to any receiving nodes within range of its transmitter, said broadcasting occurring at a specific frequency;
wherein said data comprises beliefs contained in a knowledge base of the transmitting node; and,
wherein said transmitting node and said receiving nodes are not identified in the broadcasted data.

2. The wireless data communication network of claim 1 wherein said transmitting node comprises:
a coordination means to coordinate communications between the transmitting node and said receiving nodes;
a data link means to transmit data between said transmitting node and said receiving nodes; and,
a knowledge administration means to maintain the transmitting node's knowledge base.

3. The wireless data communication network of claim 2 wherein said transmitting node comprises a sensor.

4. The wireless data communication network of claim 3 wherein said knowledge administration means comprises a receiving means for receiving information from an information source, said information source selected from the group consisting of a sensor co-located with said transmitting node, data received from at least one other node, and combinations thereof.

5. The wireless data communication network of claim 4 wherein said knowledge administration means comprises a generation means for generation of beliefs to be transmitted.

6. The wireless data communication network of claim 5 wherein said coordination means comprises:
a means for periodically transmitting a synch pulse signal from said transmitting node; and,
a means for determining N, the number of nodes proximate to the transmitting node by detecting pulse signals emanating from said proximate nodes.

7. The wireless data communication network of claim 6 wherein said coordination means comprises a means for using N to adjust the phase of transmissions occurring between proximate nodes.

8. The wireless data communication network of claim 6 wherein said coordination means comprises a means for utilizing coupled oscillation principles.

9. The wireless data communication network of claim 6 wherein said generation means utilizes N to determine beliefs to be transmitted.

10. The wireless data communication network of claim 4 wherein said knowledge administration means comprises entering updated beliefs in the transmitting node's knowledge base when appropriate.

11. The wireless data communication network of claim 10 wherein said generation means determines beliefs to be transmitted based on the occurrence of said updated beliefs.

12. In a wireless data communication network, said network comprising at least two nodes, each of said nodes having a transmitter and a receiver; a method of communicating between a transmitting node and at least one receiving node, said method comprising:
broadcasting data by said transmitting node to any receiving nodes within range of its transmitter, said broadcasting occurring at a specific frequency;
wherein said data comprises beliefs contained in a knowledge base of the transmitting node; and,
wherein said transmitting node and said receiving nodes are not identified in the broadcasted data.

13. The method of communication of claim 12 further comprising:
coordinating communications between the transmitting node and said receiving nodes;
transmitting data between said transmitting node and said receiving nodes; and,
maintaining the transmitting node's knowledge base.

14. The method of communication of claim 13 wherein said maintaining step comprises receiving information from an information source, said information source selected from the group consisting of a sensor co-located with said transmitting node, data received from at least one other node, and combinations thereof.

15. The method of communication of claim 14 further comprising generating beliefs to be transmitted.

16. The method of communication of claim 15 wherein said coordinating step further comprises:
periodically transmitting a synch pulse signal from said transmitting node; and,
determining N, the number of nodes proximate to the transmitting node by detecting pulse signals emanating from said proximate nodes.

17. The method of communication of claim 16 wherein said coordinating step further comprises:
utilizing N to adjust the phase of transmissions occurring between proximate nodes.

18. The method of communication of claim 15 wherein said generating step comprises utilizing N to determine beliefs to be transmitted.

19. The method of communication of claim 13 wherein said maintaining step comprises entering updated beliefs in the transmitting node's knowledge base when appropriate.

20. The method of communication of claim 19 wherein said generating step comprises determining beliefs to be transmitted based on the occurrence of said updated beliefs.
